(19) United States
(12) Patent Application Publication
(10) Pub. No.: US 2026/0288029 A1
(43) Pub. Date: Sep. 24, 2026

(54) TONER, METHOD FOR PRODUCING TONER, TWO-COMPONENT DEVELOPER CONTAINING TONER, AND IMAGE FORMING DEVICE USING TONER

(71) Applicant: SHARP KABUSHIKI KAISHA, Osaka (JP)

(72) Inventors: Naomi TOMITA, Osaka (JP); Tadanori Kano, Osaka (JP)

(21) Appl. No.: 19/558,793

(22) Filed: Mar. 6, 2026

(30) Foreign Application Priority Data
Mar. 21, 2025 (JP) 2025-047032

(51) Int. Cl. G03G 9/113; G03G 9/107

(52) U.S. Cl. CPC G03G 9/1138; G03G 9/108; G03G 9/1131; G03G 9/1139

(57) ABSTRACT

A toner composed at least of a toner base particle and an external additive externally added to a surface of the toner base particle, wherein the external additive includes fatty acid metal salt particles and silica particles; at least some of the fatty acid metal salt particles are embedded in the toner base particle, a ratio of a number N of the embedded fatty acid metal salt particles to 100 arbitrarily extracted fatty acid metal salt particles in the surface of the toner base particle is 90% or more; a ratio SM between the fatty acid metal salt particles in the toner before and after external additive removal treatment is 90% or more; the silica particles include at least large silica particles having an average primary particle size of from 60 to 180 nm; and a ratio SS/SM of a ratio SS between the silica particles before and after the external additive removal treatment to the ratio SM is less than 1.

### FIELD OF THE INVENTION

The disclosure relates to a toner, a method for producing the toner, a two-component developer containing the toner, and an image forming device using the toner.

### BACKGROUND ART

In recent years, with the remarkable development of office automation equipment, image forming devices (electrophotographic apparatuses), such as digital copiers, printers, and facsimile machines using an electrophotographic system, have become widespread.

In addition, with the increase in deployment of contact charging systems using roller charging and the growing trend toward longer life, smaller size, and higher speed of image forming devices, image forming devices and toners used in them are required to have various functions.

For example, from the viewpoint of energy saving, the toner is required to have low-temperature fixability, and has a lowered melting point. When such a low-temperature fixing toner is used, filming may occur in a high-temperature and high-humidity environment (HH environment). That is, scratches due to a cleaning blade or scratches due to an external additive such as silica particles having a large particle size externally added to the toner are generated on the surface of an electrophotographic photoreceptor (also referred to as “drum” or “photoreceptor”) of an image forming device, and the external additive detached from the toner is embedded in the scratches. Then, the toner softened in the HH environment adheres, starting from protruding portions formed by the embedded external additive, thereby causing filming (toner filming).

As a method for solving such problems in the low-temperature fixing toner, a toner to which fatty acid metal salt particles are externally added as an external additive to achieve a liberation rate of from 30 to 90 mass % has been proposed. It is considered that, in the toner, excellent cleaning properties can be maintained throughout the life by appropriately liberating the fatty acid metal salt particles.

### SUMMARY

Accordingly, an object of the disclosure is to provide a toner that can exhibit suppression of filming in a high-temperature and high-humidity environment, a method for producing the toner, a two-component developer containing the toner, and an image forming device using the toner.

As a result of intensive studies to solve the above problems, the inventors have found that, in a toner composed at least of a toner base particle and an external additive, when the external additive includes fatty acid metal salt particles and silica particles including particles having a specific particle size, the fatty acid metal salt particles are embedded in the toner base particles at a specific ratio, and the fatty acid metal salt particles and the silica particles each have a specific adhesion strength, the fatty acid metal salt particles are hardly detached from the toner, adhesion of the toner is suppressed, lubricity of the toner particles is retained without being reduced, and toner filming in a high-temperature and high-humidity environment can be suppressed, and thus have completed the disclosure.

The above prior art does not disclose the adhesion strengths of the fatty acid metal salt particles and the silica particles, nor the state of the fatty acid metal salt particles embedded in the toner base particles.

Thus, according to the disclosure, there is provided a toner composed at least of a toner base particle and an external additive externally added to a surface of the toner base particle, wherein the external additive includes fatty acid metal salt particles and silica particles, at least some of the fatty acid metal salt particles are embedded in the toner base particle, a ratio (N/100)×100 (embedding rate) % is 90% or more, the ratio (N/100) being a ratio of a number N of the fatty acid metal salt particles embedded in the toner base particle to 100 arbitrarily extracted fatty acid metal salt particles, in the surface of the toner base particle including the fatty acid metal salt particles embedded in the toner base particle, a ratio SM, which is A/B×100 (adhesion strength) %, is 90% or more, the A/B being a ratio of an X-ray intensity A derived from a metallic element of the fatty acid metal salt particles using 1 g of the toner after external additive removal treatment as a specimen to an X-ray intensity B derived from the metallic element of the fatty acid metal salt particles using 1 g of the toner before the external additive removal treatment as a specimen, in fluorescent X-ray analysis with an irradiation diameter of 30 mm, the silica particles include at least large silica particles having an average primary particle size of from 60 to 180 nm, and a ratio SS/SM of a ratio SS to the ratio SM is less than 1, the ratio SS being C/D×100 (adhesion strength) %, the C/D being a ratio of an X-ray intensity C derived from an Si element of the silica particles using 1 g of the toner after the external additive removal treatment as a specimen to an X-ray intensity D derived from the Si element of the silica particles using 1 g of the toner before the external additive removal treatment as a specimen, in the fluorescent X-ray analysis with the irradiation diameter of 30 mm.

According to the disclosure, there is also provided a method for producing the toner described above, including:
a kneading step S1 of mixing and melt-kneading toner raw materials to obtain a kneaded product;
a pulverization step S2 of pulverizing the obtained kneaded product to obtain pulverized toner particles;
a classification step S3 of classifying the obtained pulverized toner particles to obtain toner base particles;
an external addition step S4 of adding large silica particles and fatty acid metal salt particles as external additives to the obtained toner base particles to obtain external additive toner particles; and
a fixation step S5 of heat-treating the obtained external additive toner particles to fix or embed the particles of the external additives to/in a toner surface to obtain a toner; and optionally, a second external addition step S6 of further adding small silica particles as an external additive to the obtained toner.

Moreover, according to the disclosure, there is provided a two-component developer containing the toner described above and a carrier.

Also, according to the disclosure, there is provided an image forming device that forms an image by forming an electrostatic latent image on a surface of an electrophotographic photoreceptor and transferring a toner developed on the electrostatic latent image to a transfer receiving material, wherein the toner is the toner described above.

According to the disclosure, it is possible to provide a toner that can exhibit suppression of filming in a high-temperature and high-humidity environment, a method for producing the toner, a two-component developer containing the toner, and an image forming device using the toner.

### BRIEF DESCRIPTION OF THE DRAWINGS

FIG. 1 is a diagram illustrating a mechanism of occurrence of filming in a high-temperature and high-humidity environment.

FIG. 2 is a diagram illustrating a mechanism of exhibiting an effect of the toner of the disclosure.

FIG. 3 is an SEM image of the toner of the disclosure in which (3a) fatty acid metal salt particles are embedded in a toner surface, and (3b) a known toner in which fatty acid metal salt particles adhere to a toner surface, respectively.

FIG. 4 is a schematic side view showing an example of a configuration of a main portion of an image forming device 100 of the disclosure.

FIG. 5 is a mathematical expression for calculating a coverage by an external additive.

FIG. 6 is a table showing constitutions of toners and two-component developers of Examples, preparation conditions and physical properties thereof, and evaluation results.

FIG. 7 is a table showing constitutions of toners and two-component developers of Comparative Examples, preparation conditions and physical properties thereof, and evaluation results.

### DESCRIPTION OF EMBODIMENTS

The toner of the disclosure is a toner composed at least of a toner base particle and an external additive externally added to a surface of the toner base particle, characterized in that:
the external additive includes fatty acid metal salt particles and silica particles,
at least some of the fatty acid metal salt particles are embedded in the toner base particle,
a ratio (N/100)×100 (embedding rate) % is 90% or more, the ratio (N/100) being a ratio of a number N of the fatty acid metal salt particles embedded in the toner base particle to 100 arbitrarily extracted fatty acid metal salt particles, in the surface of the toner base particle including the fatty acid metal salt particles embedded in the toner base particle,
a ratio SM, which is A/B×100 (adhesion strength) %, is 90% or more, the A/B being a ratio of an X-ray intensity A derived from a metallic element of the fatty acid metal salt particles using 1 g of the toner after external additive removal treatment as a specimen to an X-ray intensity B derived from the metallic element of the fatty acid metal salt particles using 1 g of the toner before the external additive removal treatment as a specimen, in fluorescent X-ray analysis with an irradiation diameter of 30 mm,
the silica particles include at least large silica particles having an average primary particle size of from 60 to 180 nm, and
a ratio SS/SM of a ratio SS to the ratio SM is less than 1, the ratio SS being C/D×100 (adhesion strength) %, the C/D being a ratio of an X-ray intensity C derived from an Si element of the silica particles using 1 g of the toner after the external additive removal treatment as a specimen to an X-ray intensity D derived from the Si element of the silica particles using 1 g of the toner before the external additive removal treatment as a specimen, in the fluorescent X-ray analysis with the irradiation diameter of 30 mm.

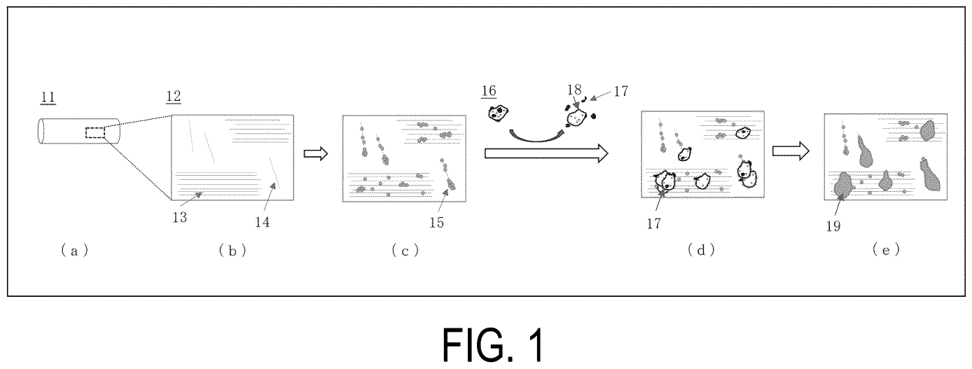

FIG. 1 is a diagram illustrating a mechanism of occurrence of filming in a high-temperature and high-humidity environment.

A drum surface 12 in FIG. 1(b) is an enlarged view of a region of a drum (electrophotographic photoreceptor) 11 surrounded by a dotted line in FIG. 1(a), and first, as shown in FIG. 1(b), a blade scratch 13 and a pass-through scratch 14 formed by a silica particle having a relatively large particle size (large silica particle) are generated. Then, as shown in FIG. 1(c), the large silica particles detached from the toner are embedded in the scratches on the drum surface, that is, the blade scratch 13 and the pass-through scratch 14. Therefore, fatty acid metal salt particles 17 are detached from a toner 16 in a development tank of the image forming device, and a toner 18 from which the fatty acid metal salt particles have been detached is generated. Next, as shown in FIG. 1(d), the toner 18 from which the fatty acid metal salt particles have been detached adheres to the drum surface, starting from the large silica particles embedded in the scratches on the drum surface. Next, as shown in (1e), the adhering toner 18 adheres to the drum surface while being stretched in a rotational direction of the drum 12, whereby toner filming occurs.

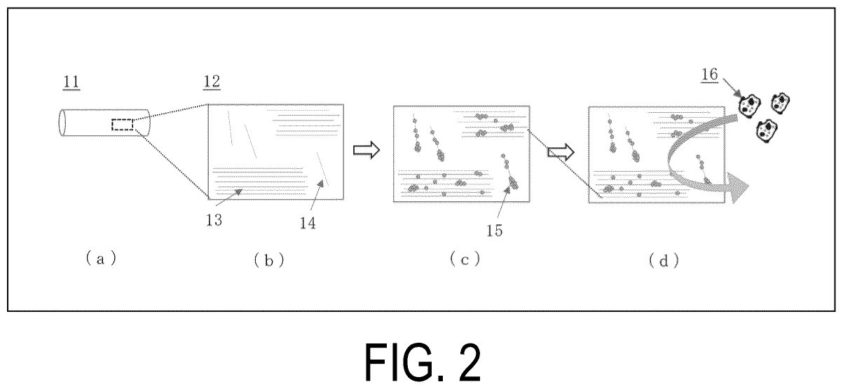

On the other hand, FIG. 2 is a diagram illustrating a mechanism of exhibiting an effect of the toner of the disclosure.

As shown in FIG. 2(a) to FIG. 2(c), the blade scratch 13 and the pass-through scratch 14 are generated, and the large silica particles detached from the toner are embedded in the scratches on the drum surface as in FIG. 1. However, the inventors of the disclosure consider that, in the toner of the disclosure, as shown in FIG. 2(d), because of lubricity of the fatty acid metal salt particles present on the toner surface (embedded in the toner), the toner 16 has low adhesion and does not adhere to the drum surface, and thus does not cause toner filming.

Hereinafter, constituent features which are characteristics of the toner of the disclosure will be described, and then (1) the toner, (2) a method for producing the toner, (3) a two-component developer containing the toner, and (4) an image forming device using the toner will be described. Note that embodiments and Examples described below are merely specific examples of the disclosure, and the disclosure is not limited thereto.

An external additive of the toner generally has functions of improving conveyability and chargeability of the toner as well as stirrability of the toner with a carrier when the toner is used in a two-component developer.

The toner of the disclosure includes at least fatty acid metal salt particles and silica particles as external additives, and if necessary, other external additives used in the art can be appropriately selected and used as long as the effects of the toner of the disclosure are not inhibited. One of these other external additives may be used alone, or two or more thereof may be used in combination. Examples of other external additives include inorganic fine particles such as titanium oxide, alumina, and metal titanate, and organic resin fine particles.

### Fatty Acid Metal Salt Particle

The fatty acid metal salt particles are particles of a salt consisting of a fatty acid and a metal.

The fatty acid may be either a saturated fatty acid or an unsaturated fatty acid, and the number of carbon atoms thereof (including a carbon atom of a carboxy group) is preferably from 10 to 25, and more preferably from 12 to 22.

Examples of the fatty acid include saturated fatty acids such as behenic acid, stearic acid, palmitic acid, myristic acid, and lauric acid; and unsaturated fatty acids such as oleic acid, linoleic acid, and ricinoleic acid. Among these fatty acids, fatty acids having 15 or more carbon atoms are preferable, and stearic acid is more preferable.

As the metal, a divalent metal is preferable, and examples thereof include magnesium, calcium, aluminum, barium, and zinc, and among these, zinc is preferable.

Examples of the fatty acid metal salt particles include particles of metal salts of stearic acid such as aluminum stearate, calcium stearate, potassium stearate, magnesium stearate, barium stearate, lithium stearate, zinc stearate, copper stearate, lead stearate, nickel stearate, strontium stearate, cobalt stearate, and sodium stearate; metal salts of palmitic acid such as zinc palmitate, cobalt palmitate, copper palmitate, magnesium palmitate, aluminum palmitate, and calcium palmitate; metal salts of lauric acid such as zinc laurate, manganese laurate, calcium laurate, iron laurate, magnesium laurate, and aluminum laurate; metal salts of oleic acid such as zinc oleate, manganese oleate, iron oleate, aluminum oleate, copper oleate, magnesium oleate, and calcium oleate; metal salts of linoleic acid such as zinc linoleate, cobalt linoleate, and calcium linoleate; and metal salts of ricinoleic acid such as zinc ricinoleate and aluminum ricinoleate. Among these, stearic acid metal salt particles are preferable.

More specifically, the fatty acid metal salt particles are preferably zinc stearate particles or calcium stearate particles, and more preferably zinc stearate particles.

A method for producing the fatty acid metal salt particles is not particularly limited, and examples thereof include a method in which a fatty acid alkali metal salt is cationically substituted and a method in which a fatty acid is directly reacted with a metal hydroxide. When a method for producing the zinc stearate particles as the fatty acid metal salt particles is taken as an example, examples of the method include a method for cationically substituting sodium stearate and a method for reacting stearic acid with zinc hydroxide.

### Average Primary Particle Size of Fatty Acid Metal Salt Particle

The fatty acid metal salt particles preferably have an average primary particle size of 1.5 μm or less, and more preferably have an average primary particle size of from 0.1 to 1.0 μm. When the average primary particle size of the fatty acid metal salt particles is less than 0.1 μm, the fatty acid metal salt particles are excessively embedded in the surface of the toner base particle, and thus an effective area of the fatty acid metal salt particles present on the surface is reduced, and thus it may be difficult to obtain desired effects. On the other hand, when the average primary particle size of the fatty acid metal salt particles exceeds 1.0 μm, embedding of the particles becomes weak, which may cause the particles to be easily detached. Further, when the average primary particle size exceeds 1.5 μm, embedding of the particles becomes even weaker, which may cause the particles to be easily detached.

### Coverage of Fatty Acid Metal Salt Particle

The fatty acid metal salt particles preferably have a coverage of from 4 to 40% with respect to the surface of the toner base particle.

When the coverage of the fatty acid metal salt particles is less than 4%, the effect of suppressing the adhesion of the toner particles may be reduced. On the other hand, when the coverage of the fatty acid metal salt particles is more than 40%, the chargeability of the toner is reduced due to the effect of the fatty acid metal salt particles to reduce the chargeability, and image defects (non-uniform image density) may easily occur.

The coverage of the fatty acid metal salt particles is more preferably from 5 to 20%, and particularly preferably from 5 to 10%.

A method for measuring the coverage will be described in detail in Examples which will be described later.

### Embedding Rate of Fatty Acid Metal Salt Particle

At least some of the fatty acid metal salt particles are embedded in the toner base particle, and a ratio (N/100)×100 (embedding rate) % is 90% or more, the ratio (N/100) being a ratio of a number N of the fatty acid metal salt particles embedded in the toner base particle to 100 arbitrarily extracted fatty acid metal salt particles, in the surface of the toner base particle including the fatty acid metal salt particles embedded in the toner base particle.

When the embedding rate of the fatty acid metal salt particles is less than 90%, the detached (liberated) fatty acid metal salt particles are aggregated, and image defects (non-uniform density) may easily occur.

The embedding rate of the fatty acid metal salt particles is preferably 92% or more, and more preferably 92% or more and less than 98%. While a higher filming resistance in a high-temperature and high-humidity (HH) environment is better, setting the embedding rate within a more preferable range makes it possible to suppress also filming in a low-temperature and low-humidity (LL) environment (the effect is exhibited due to the detached fatty acid metal salt adhering to the blade to increase cleaning properties), when the fatty acid metal salt that is detached in the development tank is present.

A method for measuring the embedding rate will be described in detail in Examples which will be described later.

### Degree of Embedding of Fatty Acid Metal Salt Particle

An average value of a ratio (SB/ST)×100 (degree of embedding) % is preferably from 10 to 80%, the ratio (SB/ST) being a ratio of an area SB of portions of the fatty acid metal salt particles embedded in the toner base particle to an area ST of the 100 arbitrarily extracted fatty acid metal salt particles embedded in the toner base particle, in a cross section of the toner base particle including the fatty acid metal salt particles embedded in the toner base particle. When the degree of embedding of the fatty acid metal salt particles is less than 10%, the fatty acid metal salt particles may be easily detached from the toner base particle. On the other hand, when the degree of embedding of the fatty acid metal salt particles is more than 80%, portions of the fatty acid metal salt particles exposed on the toner surface are reduced, and the effect of suppressing the adhesion of the toner particles may be reduced.

The degree of embedding of the fatty acid metal salt particles is more preferably from 20 to 60%, and particularly preferably from 30 to 50%.

A method for measuring the degree of embedding will be described in detail in Examples which will be described later.

### Adhesion Strength of Fatty Acid Metal Salt Particle

In the fatty acid metal salt particle, a ratio SM, which is A/B×100 (adhesion strength) %, is 90% or more, the A/B being a ratio of an X-ray intensity A derived from a metallic element of the fatty acid metal salt particles using 1 g of the toner after external additive removal treatment as a specimen to an X-ray intensity B derived from the metallic element of the fatty acid metal salt particles using 1 g of the toner before the external additive removal treatment as a specimen, in fluorescent X-ray analysis with an irradiation diameter of 30 mm.

When the adhesion strength of the fatty acid metal salt particles is less than 90%, the fatty acid metal salt particles are detached, the effect of suppressing the adhesion of the toner particles is reduced, and image defects due to the detached fatty acid metal salt particles may easily occur. The adhesion strength of the fatty acid metal salt particles is preferably 92% or more, and more preferably from 92 to 98%. The adhesion strength is preferably 94% or more.

A method for measuring the adhesion strength will be described in detail in Examples which will be described later.

### Fluorescent X-Ray Intensity of Fatty Acid Metal Salt Particle on Printed Matter

In the fatty acid metal salt particle, a ratio (P/T)×100 is preferably from 50 to 70%, the ratio (P/T) being a ratio of an X-ray intensity P derived from the metallic element of the fatty acid metal salt particles using, as a specimen, an image of 40×40 mm when a solid image is printed using the toner to an X-ray intensity T derived from the metallic element of the fatty acid metal salt particles using 1 g of the toner as a specimen, in the fluorescent X-ray analysis with the irradiation diameter of 30 mm.

When the ratio (P/T) of the X-ray intensity P is less than 50%, the fatty acid metal salt particles are detached from surfaces of the toner particles on a paper surface, and are in a state of being not attached to the paper surface, and thus, image defects due to the detached fatty acid metal salt particles may easily occur. On the other hand, when the ratio (P/T) of the X-ray intensity P is more than 70%, the fatty acid metal salt particles are in a state of remaining too much on the paper surface, and due to the lubricity thereof, image defects (positional deviation) may easily occur. The ratio (P/T) of the X-ray intensity P is more preferably from 50 to 70%, and particularly preferably from 55 to 65%.

A method for measuring the fluorescent X-ray intensity of the external additive on a printed matter will be described in detail in Examples which will be described later.

### Silica Particle

The silica particles externally added to the toner of the disclosure together with the fatty acid metal salt particles include at least large silica particles having an average primary particle size of from 60 to 180 nm.

The large silica particles have a role as a spacer, and good developability can be realized by inclusion of the large silica particles in the external additive.

The silica particles may include medium silica particles having an average primary particle size of from 20 to 60 nm and small silica particles having an average primary particle size of from 7 to 20 nm, which will be described later.

When the average primary particle size of the large silica particles is less than 60 nm, a spacer effect is hardly obtained, and image defects (low concentration) and aggregation of the toner due to a decrease in heat-resistant storage stability may easily occur. On the other hand, when the average primary particle size of the large silica particles exceeds 180 nm, fixability is inhibited, and image defects (offset) may easily occur.

The average primary particle size of the large silica particles is preferably from 80 to 120 nm, and more preferably from 80 to 120 nm.

A method for measuring the average primary particle size of the silica particles will be described in detail in Examples which will be described later.

### Silica Raw Material

The silica raw material can be produced by a known method such as a dry method (gas phase method), a wet method, or a sol-gel method, and the gas phase method is preferable in that a solvent is not used.

The gas phase method is a method of producing a silica raw material by vapor phase oxidation of a silicon halogen compound. For example, a silica raw material called dry (gas phase) silica or fumed silica is produced by a thermal decomposition oxidation reaction (basic reaction: SiCl₄+2H₂+O₂→SiO₂+4HCl) in an oxyhydrogen flame of a silicon tetrachloride gas.

Further, the silica raw material may be a composite of silica and another metal oxide obtained by using a metal halogen compound such as aluminum chloride or titanium chloride together with the silicon halogen compound in the above-described production process.

Ratio between Adhesion Strength of Fatty Acid Metal Salt Particle and Adhesion Strength of

### Silica Particle

A ratio SS/SM of a ratio SS to the adhesion strength SM of the fatty acid metal salt particle is less than 1, the ratio SS being C/D×100 (adhesion strength) %, the C/D being a ratio of an X-ray intensity C derived from an Si element of the silica particles using 1 g of the toner after the external additive removal treatment as a specimen to an X-ray intensity D derived from the Si element of the silica particles using 1 g of the toner before the external additive removal treatment as a specimen, in the fluorescent X-ray analysis with the irradiation diameter of 30 mm.

When the ratio SS/SM is more than 1, fluidity as a toner is not obtained, and the excellent effects of the toner of the disclosure may not be obtained.

The ratio SS/SM is preferably 0.90 or less. For example, in a case where the toner is produced by two external addition steps which will be described below, when the adhesion of the small silica particles to be externally added in a second external addition step after a fixation step is weak, and the adhesion strength thereof is too small, the detachment of the large silica particles causing filming increases. Therefore, a lower limit of SS/SM is about 0.60.

A method for measuring the ratio SS/SM will be described in detail in Examples which will be described later.

### Small Silica Particle

The toner of the disclosure preferably further includes, as an external additive, small silica particles having an average primary particle size of from 7 to 20 nm and surface-treated with a silicone oil.

The small silica particles can moderately improve the fluidity of the toner, and when the small silica particles are present on the surfaces of the toner particles, the improvement of the heat-resistant storage stability can be realized.

When the average primary particle size of the small silica particles is less than 7 nm, the low-temperature fixability is impaired, and therefore, image defects (low-temperature offset) may easily occur. On the other hand, when the average primary particle size of the small silica particles exceeds 20 nm, the adhesion suppressing effect of the silicone oil treatment may be difficult to obtain.

The average primary particle size of the small silica particles is more preferably from 7 to 15 nm, and particularly preferably from 10 to 15 nm.

A method for measuring the average primary particle size of the silica particles will be described in detail in Examples which will be described later.

The small silica particles surface-treated with a silicone oil have a higher effect of suppressing adhesion than silica particles surface-treated with other surface treatment agents, and therefore provide a further filming suppressing effect by combination with the fatty acid metal salt particles. The small silica particles are preferably surface-treated with hexamethyldisilazane (HMDS), dimethyldichlorosilane (DDS), octylsilane (OTAS), polydimethylsiloxane (PDMS), or the like, which is commonly used in the art. From the viewpoint of suppressing the adhesion of the toner surface, silica particles treated with PDMS are more preferable.

Not only the small silica particles but also the medium silica particles and the large silica particles may be surface-treated.

### Silicone Oil-Treated Small Silica Particle

The silicone oil-treated small silica particles include silica particles before treatment (the above-described “silica raw material”) and a silicone oil, and a specific surface area thereof by the BET method is not particularly limited, but is about from 30 to 400 m²/g.

The silicone oil-treated small silica particles can be produced by, for example, a method of directly mixing a silica raw material treated with an organosilicon compound and a silicone oil using a mixer such as a Henschel mixer, a method of spraying a silicone oil diluted with an appropriate solvent such as normal hexane onto a silica raw material followed by heat treatment, or a method of dissolving or dispersing a silicone oil in an appropriate solvent, adding and mixing a silica raw material, and removing the solvent.

The heat treatment after the spraying is preferably performed in an inert gas atmosphere such as helium, nitrogen, or argon for safety, and nitrogen gas is preferable in consideration of cost and the like.

A heat treatment temperature is preferably from 200 to 400° C.

Examples of the silicone oil include straight silicone oils such as dimethyl silicone oil, methylphenyl silicone oil, and methyl hydrogen silicone oil; and modified silicone oils such as epoxy-modified silicone oil, carboxyl-modified silicone oil, carbinol-modified silicone oil, methacryl-modified silicone oil, mercapto-modified silicone oil, phenol-modified silicone oil, single-end reactive-modified silicone oil, heterofunctional group-modified silicone oil, polyether-modified silicone oil, methylstyryl-modified silicone oil, alkyl-modified silicone oil, higher fatty acid ester-modified silicone oil, hydrophilic specially modified silicone oil, higher alkoxy-modified silicone oil, higher fatty acid-containing modified silicone oil, and fluorine-modified silicone oil. One of these can be used alone, or two or more thereof can be used in combination.

Examples of the organosilicon compound include hexamethyldisilazane, trimethylsilane, trimethylethoxysilane, isobutyltrimethoxysilane, trimethylchlorosilane, dimethyldichlorosilane, methyltrichlorosilane, dimethylethoxysilane, dimethyldimethoxysilane, diphenyldiethoxysilane, and hexamethyldisiloxane. One of these can be used alone, or two or more thereof can be used in combination.

The silicone oil-treated small silica particles can be produced by, for example, a method described in JP 6849352 B, and desired silica particles can be obtained by changing the average primary particle size of the silica particles as a base material and an amount of silicone oil used.

### (1) Toner

The toner of the disclosure is composed at least of a toner base particle and an external additive externally added to a surface of the toner base particle, and the external additive includes fatty acid metal salt particles and silica particles.

### (1-1) Toner Base Particle

The toner base particle contains at least a binder resin and may contain a known additive, such as a colorant, a release agent, and a charge control agent, as necessary, as long as the effects of the toner of the disclosure are not inhibited.

### (1-1-1) Binder Resin

The binder resin contained in the toner base particle of the toner of the disclosure is not particularly limited, and examples thereof include resins used in the art, including polyester-based resins, polystyrene-based resins such as styrene-acrylic resins, (meth)acrylic ester-based resins, polyolefin-based resins, polyurethane-based resins, and epoxy-based resins. In the toner of the disclosure, one of these resins can be used alone, or two or more thereof can be used in combination. Among these resins, a polyester-based resin (also simply referred to as “polyester resin”) is particularly preferable because physical properties of the resin can be easily controlled by setting the conditions for a polycondensation reaction as will be described below, and a binder resin having desired physical properties can be produced.

### Amorphous Polyester Resin

As the binder resin contained in the toner of the disclosure, an amorphous polyester resin can be suitably used from the viewpoint of low-temperature fixability, and components other than the amorphous polyester resin, such as a crystalline polyester resin and the other resins described above, may be contained as long as the effects of the toner of the disclosure are not inhibited.

The polyester resins can be distinguished into the amorphous polyester resin and the crystalline polyester resin according to a crystallinity index. In the disclosure, a resin having a crystallinity index of 0.6 or more and 1.5 or less is defined as the crystalline polyester resin, and a resin having a crystallinity index of less than 0.6 or more than 1.5 is defined as the amorphous polyester resin. A resin having a crystallinity index of more than 1.5 is amorphous, and a resin having a crystallinity index of less than 0.6 has low crystallinity and has many amorphous portions.

The crystallinity index is a physical property serving as an indicator of the degree of crystallinity of a resin and is defined by a ratio of a softening temperature to a maximum endothermic peak temperature (softening temperature/maximum endothermic peak temperature). Here, the maximum endothermic peak temperature refers to a temperature of a peak on the highest temperature side among endothermic peaks observed. In the crystalline polyester resin, the maximum peak temperature is defined as a melting point, and in the amorphous polyester resin, the peak on the highest temperature side is defined as a glass transition temperature.

The degree of crystallinity of the resin can be controlled by adjusting the types and ratios of monomers from which the resin is produced, production conditions (e.g., reaction temperature, reaction time, and cooling rate), and the like.

The amorphous polyester resin is obtained by, for example, polycondensation between a dicarboxylic acid monomer including terephthalic acid or isophthalic acid as a main component and a diol monomer including ethylene glycol as a main component.

A molar content rate of the terephthalic acid or isophthalic acid in the dicarboxylic acid monomer is preferably from 70 to 100%, and more preferably from 80 to 100%.

The dicarboxylic acid monomer may include an aromatic dicarboxylic acid other than terephthalic acid and isophthalic acid, an aliphatic dicarboxylic acid, an ester-forming derivative of terephthalic acid or isophthalic acid, an ester-forming derivative of an aromatic dicarboxylic acid other than terephthalic acid and isophthalic acid, or an ester-forming derivative of an aliphatic dicarboxylic acid.

Examples of the aromatic dicarboxylic acid other than terephthalic acid or isophthalic acid include fumaric acid. Examples of the aliphatic dicarboxylic acid include adipic acid, sebacic acid, and succinic acid.

The ester-forming derivatives include carboxylic acid anhydrides, alkyl esters, and the like. One of the dicarboxylic acid monomers described above may be used alone, or two or more thereof may be used in combination. In the synthesis of the amorphous polyester resin, a polycarboxylic acid monomer containing three or more carboxyl groups may be used together with the dicarboxylic acid monomer described above.

As the polycarboxylic acid monomer containing three or more carboxyl groups, polycarboxylic acids containing three or more carboxyl groups such as trimellitic acid and pyromellitic acid and ester-forming derivatives thereof can be used. One of these polycarboxylic acid monomers containing three or more carboxyl groups may be used alone, or two or more thereof may be used in combination.

The diol monomer used for synthesis of the amorphous polyester resin includes ethylene glycol as a main component.

A molar content rate of ethylene glycol in the diol monomer is preferably from 70 to 100% and more preferably from 80 to 100%.

The diol monomer may include 1,3-propylene glycol, 1,4-butanediol, and the like.

One of the diol monomers described above may be used alone, or two or more thereof may be used in combination.

The amorphous polyester resin used in the toner of the disclosure can be produced in a manner similar to a common polyester production method. For example, the amorphous polyester resin can be synthesized by a polycondensation reaction using a dicarboxylic acid monomer and a diol monomer, and optionally a polycarboxylic acid monomer containing three or more carboxyl groups, at a temperature ranging from 190° C. to 240° C. in a nitrogen gas atmosphere.

In the polycondensation reaction, a reaction ratio between the diol monomer and the carboxylic acid monomer (including the dicarboxylic acid monomer and optionally the polycarboxylic acid monomer containing three or more carboxyl groups) is preferably from 1.3:1 to 1:1.2, as [OH]:[COOH] which is an equivalent ratio between the hydroxyl group and the carboxyl group. In the polycondensation reaction, the molar content rate of the dicarboxylic acid monomer in the carboxylic acid monomer is preferably from 80 to 100%. Further, in the polycondensation reaction, an esterification catalyst such as dibutyltin oxide or titanium alkoxide (for example, tetrabutoxy titanate) may be used if necessary.

A content of the amorphous polyester resin in the toner base particle of the disclosure is preferably from 40 to 95 mass %, and more preferably from 50 to 80 mass %.

### Crystalline Polyester Resin

In the toner of the disclosure, the toner base particle may contain a crystalline polyester resin. In general, it is known that the crystalline polyester resin can reduce the softening temperature and melt viscosity of the toner, and that the low-temperature fixability of the toner can be improved by using the crystalline polyester resin in combination with the amorphous polyester resin.

The crystalline polyester resin in the toner particles is dispersed in the amorphous polyester resin. The crystalline polyester resin is a crystalline polyester resin composed of a linear saturated aliphatic polyester unit obtained through polycondensation between a dicarboxylic acid monomer including an aliphatic dicarboxylic acid having from 9 to 22 carbon atoms as a main component and a diol monomer including an aliphatic diol having from 2 to 10 carbon atoms as a main component. The crystalline polyester composed of the linear saturated aliphatic polyester unit lowers compatibility between this crystalline polyester resin and the amorphous polyester resin.

The dicarboxylic acid monomer used for synthesis of the crystalline polyester resin includes an aliphatic dicarboxylic acid having from 9 to 22 carbon atoms as a main component. Here, a molar content rate of the aliphatic dicarboxylic acid having from 9 to 22 carbon atoms in the dicarboxylic acid monomer is preferably from 80 to 100%.

Examples of the aliphatic dicarboxylic acid having from 9 to 22 carbon atoms include azelaic acid, sebacic acid, 1,10-decanedicarboxylic acid, and 1,18-octadecanedicarboxylic acid. The dicarboxylic acid monomer may also include ester-forming derivatives of these aliphatic dicarboxylic acids. One of these dicarboxylic acid monomers may be used alone, or two or more thereof may be used in combination.

In the synthesis of the crystalline polyester resin, a polycarboxylic acid monomer containing three or more carboxyl groups may be used together with the dicarboxylic acid monomer. Examples of the polycarboxylic acid monomer containing three or more carboxyl groups include polycarboxylic acids containing three or more carboxyl groups such as trimellitic acid and pyromellitic acid and ester-forming derivatives thereof. One of these polycarboxylic acid monomers containing three or more carboxyl groups may be used alone, or two or more thereof may be used in combination.

The diol monomer used for synthesis of the crystalline polyester resin includes an aliphatic diol having from 2 to 10 carbon atoms as a main component. Here, a molar content rate of the aliphatic diol having from 2 to 10 carbon atoms in the diol monomer is preferably from 80 to 100%.

Examples of the aliphatic diol having from 2 to 10 carbon atoms include ethylene glycol, 1,4-butanediol, and 1,6-hexanediol. One of these diol monomers may be used alone, or two or more thereof may be used in combination.

In the synthesis of the crystalline polyester resin, a polyol monomer containing three or more hydroxyl groups may be used together with the diol monomer. Examples of the polyol monomer containing three or more hydroxyl groups include glycerol and trimethylolpropane. One of these polyol monomers containing three or more hydroxyl groups may be used alone, or two or more thereof may be used in combination.

The crystalline polyester resin used in the toner according to the present embodiment can be produced in a manner similar to a common polyester production method. For example, the crystalline polyester resin can be synthesized by a polycondensation reaction using a dicarboxylic acid monomer and a diol monomer, and optionally a polycarboxylic acid monomer containing three or more carboxyl groups or a polyol monomer containing three or more hydroxyl groups, in a temperature ranging from 190 to 240° C. in a nitrogen gas atmosphere.

In the above-described polycondensation reaction, an equivalent ratio of the hydroxyl group of the polyol monomer (including the diol monomer and optionally the polyol monomer containing three or more hydroxyl groups) to the carboxyl group of the carboxylic acid monomer (including the dicarboxylic acid monomer and optionally the polycarboxylic acid monomer containing three or more carboxyl groups) (OH group/COOH group) is preferably from 0.83 to 1.3, from the viewpoint of storage stability and the like. In the polycondensation reaction, a molar content rate of the dicarboxylic acid monomer in the carboxylic acid monomer is preferably from 90 to 100%.

A lower molar content rate of the dicarboxylic acid monomer results in a decrease in the level or rate of crystallization, and insufficient toner aggregation resistance. Also, in the polycondensation reaction, a molar content rate of the diol monomer in the polyol monomer is preferably from 80 to 100%. In the polycondensation reaction, an esterification catalyst such as dibutyltin oxide or titanium alkoxide (for example, tetrabutoxy titanate) may be used if necessary. A content of the crystalline polyester resin in the toner particles of the disclosure is preferably from 5 to 50 mass %, and more preferably from 10 to 30 mass %.

### (1-1-2) Colorant

The toner base particle of the toner of the disclosure may include a colorant.

The colorant is not particularly limited, and examples thereof include organic dyes, organic pigments, inorganic dyes, and inorganic pigments commonly used in the art. A plurality of colorants can be used in combination.

In addition, two or more colorants may be used in the form of composite particles. The composite particles can be produced, for example, by adding appropriate amounts of water, a lower alcohol, and/or the like to two or more colorants, granulating the mixture with a common granulator, such as a high-speed mill, and drying the granulated mixture. Furthermore, to uniformly disperse the colorant in the binder resin, the colorant may be used in the form of masterbatch. The composite particles and masterbatch are mixed into a toner composition during dry mixing.

Examples of black colorants include carbon black, copper oxide, manganese dioxide, aniline black, activated carbon, nonmagnetic ferrite, magnetic ferrite, and magnetite.

Examples of yellow colorants include chrome yellow, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of magenta colorants include red iron oxide, cadmium red, red lead, mercury sulfide, cadmium, Permanent Red 4R, Lithol Red, pyrazolone red, watching red, calcium salts, Lake Red C, Lake Red D, Brilliant Carmine 6B, eosin lake, Rhodamine Lake B, alizarin lake, Brilliant Carmine 3B, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of cyan colorants include iron blue, cobalt blue, alkali blue lake, victoria blue lake, phthalocyanine blue, metal-free phthalocyanine blue, partially chlorinated phthalocyanine blue, Fast Sky Blue, Indanthrene Blue BC, C.I. Pigment Blue 15, C.I. Pigment Blue 15:2, C.I. Pigment Blue 15:3, C.I. Pigment Blue 16, and C.I. Pigment Blue 60.

A content of the colorant in the toner base particle of the disclosure is not particularly limited, but is preferably from 4 to 10 mass %, and more preferably from 5 to 8 mass % in the toner base particle.

The colorant contained in the amount in the above range enables formation of an image with high image density and very good image quality without impairing various physical properties of the toner.

### (1-1-3) Release Agent

The toner base particle of the toner of the disclosure may include a release agent.

The release agent is not particularly limited, and examples thereof include release agents such as waxes commonly used in the art. A plurality of release agents can be used in combination.

The release agent is preferably an ester wax, and particularly preferably an ester wax in which (T1−T2) is from 15 to 30° C., more preferably from 17 to 23° C. or less, where T1 is an endothermic peak temperature at the time of temperature rise derived from the ester wax and T2 is an exothermic peak temperature at the time of cooling derived from the ester wax, the endothermic peak temperature and the exothermic peak temperature being measured using a differential scanning calorimeter.

The ester wax in which (T1−T2) satisfies the above condition has a high internal slipping effect (effect of enhancing material compatibility during melt-kneading), and blending such a wax into the toner particles makes it possible to suppress local charge-up even in a low-humidity environment, and also to suppress embedding of the external additive throughout the life. That is, it is possible to realize a toner having excellent environmental charge stability and excellent charge stability throughout the life.

Examples of the ester wax include products available from NOF CORPORATION under product names: NISSAN ELECTOL WE-14, NISSAN ELECTOL WE-15, and NISSAN ELECTOL WEP-5.

A content of the release agent in the toner base particle of the disclosure is not particularly limited, but is preferably from 0.5 to 8 mass %, and more preferably from 2 to 7 mass % in the toner base particle.

The release agent contained in the amount in the above range enables formation of an image with high image density and very good image quality without impairing various physical properties of the toner.

### (1-1-4) Charge Control Agent

The toner particles of the toner of the disclosure may include a charge control agent.

The charge control agent has a function of imparting preferable chargeability to the toner.

The charge control agent is not particularly limited, and charge control agents for positive charge control and negative charge control used in the art can be used.

Examples of a charge control agent for positive charge control include quaternary ammonium salts, pyrimidine compounds, triphenylmethane derivatives, guanidine salts, and amidine salts.

Examples of a charge control agent for negative charge control include metal-containing azo compounds, azo complex dyes, metal complexes and metal salts of salicylic acid and derivatives thereof (the metal being chromium, zinc, zirconium, or the like), organic bentonite compounds, and boron compounds.

In the toner of the disclosure, one of the charge control agents described above can be used alone, or two or more thereof can be used in combination.

A content of the charge control agent in the toner base particle of the disclosure is not particularly limited, but is preferably from 0.5 to 5 mass %, and more preferably from 0.5 to 2 mass % in the toner base particle.

The charge control agent contained in the amount in the above range enables formation of an image with high image density and very good image quality without impairing various physical properties of the toner.

### (1-2) External Additive

The external additive constituting the toner of the disclosure, specifically, the fatty acid metal salt particles and the silica particles, and the optional small silica particles are as described for the constituent features which are characteristics of the toner.

### (2) Method for Producing Toner

A method for producing the toner of the disclosure is characterized by including:
a kneading step S1 of mixing and melt-kneading toner raw materials to obtain a kneaded product;
a pulverization step S2 of pulverizing the obtained kneaded product to obtain pulverized toner particles;
a classification step S3 of classifying the obtained pulverized toner particles to obtain toner base particles;
an external addition step S4 of adding large silica particles and fatty acid metal salt particles as external additives to the obtained toner base particles to obtain external additive toner particles; and
a fixation step S5 of heat-treating the obtained external additive toner particles to fix or embed the particles of the external additives to/in a toner surface to obtain a toner; and
optionally, a second external addition step S6 of further adding small silica particles as an external additive to the obtained toner.

The method for producing a toner of the disclosure is not particularly limited, but according to the production method of the disclosure, the toner of the disclosure can be suitably produced.

### (2-1) Kneading Step S1

In the kneading step S1, the binder resin, the release agent, the colorant, and the charge control agent, which are the raw materials for the toner particles, are mixed by a mixer such as a Henschel mixer, and then kneaded using a kneading machine to obtain a kneaded product.

The kneading is performed by heating to a temperature equal to or higher than the softening point of the binder resin and lower than the thermal decomposition temperature. This melts or softens the binder resin, and allows the colorant, the release agent, the charge control agent, and the like to be dispersed in the binder resin. The specific heating temperature during kneading is, for example, from 80 to 200° C., more preferably from 100 to 150° C.

As the kneading machine, a kneading machine such as a kneader, a twin-screw extruder, a two-roll mill, a three-roll mill, or Labo Plastomill can be used. Examples of such a kneading machine include single-screw and twin-screw extruders such as TEM-100B (trade name, available from Toshiba Machine Co., Ltd.); and open roll type kneading machines such as Kneadex (trade name, available from Mitsui Mining Corporation). The kneading step may be performed using a plurality of kneading machines.

### (2-2) Pulverization Step S2

In the pulverization step S2, the kneaded product obtained in the kneading step S1 is solidified by cooling or the like, the solidified product is coarsely pulverized to obtain a coarsely pulverized product (coarse pulverization step), and the coarsely pulverized product is further finely pulverized (fine pulverization step).

Examples of a pulverizer for the coarse pulverization include a speed mill, a hammer mill, and a cutter mill.

Examples of a fine pulverizer for the fine pulverization include a jet type pulverizer that performs pulverization using a supersonic jet stream, and an impact type pulverizer that performs pulverization by introducing the coarsely pulverized product into a space formed between a rotor (rotor) rotating at a high speed and a stator (liner).

The finely pulverized particles obtained in the pulverization step S2 may be recovered as toner particles without performing the following classification step S3.

### (2-3) Classification Step S3

In the classification step S3, the finely pulverized particles obtained in the pulverization step S2 are classified using a classifier to obtain, for example, fine particles having a volume average particle size of from 4 to 8 μm.

Examples of the classifier include a rotary air classifier (rotary air classifier).

### (2-4) External Addition Step S4

The external addition step S4 includes a first A external addition step of mixing the fine particles (toner base particles) obtained in the classification step S3 and silica particles including at least large silica particles having an average primary particle size of from 60 to 180 nm to adhere the large silica particles to the surfaces of the toner base particles, and a first B external addition step of mixing fatty acid metal salt particles preferably having an average primary particle size of from 0.1 to 1.0 μm and the toner particles to adhere the fatty acid metal salt particles to the surfaces of the toner particles.

In the method for producing a toner of the disclosure, the first B external addition step is preferably performed after the first A external addition step. By externally adding the particles in this order, an optimal adhesion strength is easily obtained. When the fatty acid metal salt particles are added simultaneously with the large silica particles or added before the large silica particles, aggregates of the large silica particles and the fatty acid metal salt particles are easily formed since the charge polarity of the silica and the fatty acid metal salt is usually opposite, and there is a concern that the dispersed state of the large silica particles and the fatty acid metal salt particles on the surfaces of the toner particles becomes non-uniform. The aggregates of the large silica particles and the fatty acid metal salt particles are hardly fixed to the surfaces of the toner particles in the subsequent fixation step S5, and therefore, an optimum adhesion strength is hardly obtained.

### (2-5) Fixation Step S5

In the fixation step S5, the external additive particles of the first external additive obtained in the first external addition step S4 are fixed to the surfaces of the toner particles by a heat treatment method (hot air treatment).

For the hot air treatment, for example, a surface modifier Meteorainbow (available from Nippon Pneumatic Mfg. Co., Ltd.) can be used. In a hot air type treatment device, in order to prevent aggregation of the untreated base particles before the treatment with hot air, air is supplied from a secondary air injection nozzle to cause the untreated base particles to collide with a collision member. The untreated base particles are made spherical with hot air to form toner base particles, and then the toner base particles are cooled with cooling air to prevent thermal fusion between the toner base particles.

A supply amount of air from the secondary air injection nozzle is preferably from 200 to 250 L/min. If the supply amount of the air from the secondary air injection nozzle is too large, the untreated base particles may be damaged by the collision member, and if the supply amount is too small, the untreated base particles are likely to aggregate.

The supply amount of the hot air is preferably from 700 to 1500 L/min. If the supply amount of the hot air is too large, the untreated base particles are melted more than necessary, and if the supply amount is too small, the untreated base particles may not be sufficiently fixed.

A temperature of the hot air is preferably from 50 to 250° C. If the temperature of the hot air is too high, the untreated base particles are melted more than necessary, and if the temperature is too low, the spheroidization treatment of the untreated base particles takes time.

A supply pressure of the cooling air is preferably from 0.1 to 0.3 MPa. If the supply pressure of the cooling air is too high, the toner base particles may not be sufficiently cooled, and if the supply pressure is too low, the cooling treatment of the toner base particles takes time.

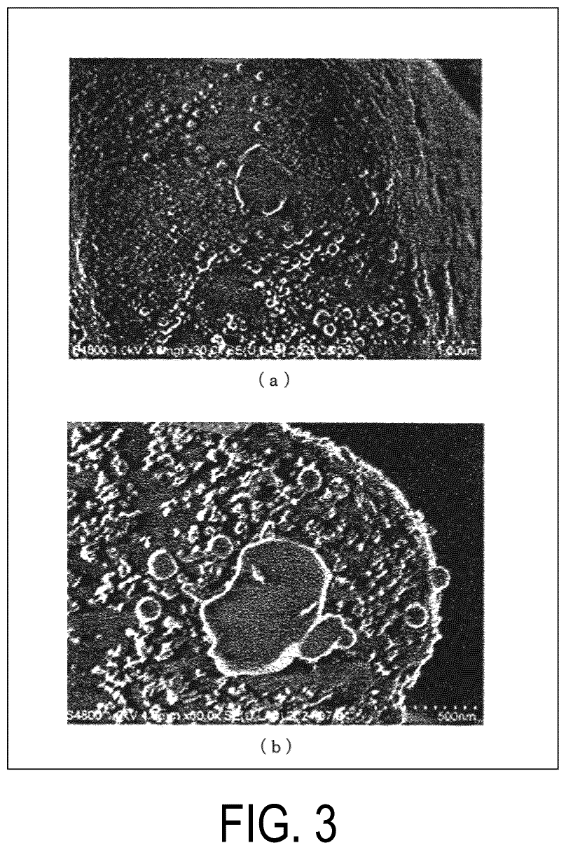

Without the fixation step, the fatty acid metal salt particles are merely in a state of adhering to a toner surface as in the known toner, that is, as shown in FIG. 3(b). On the other hand, the fixation step causes the fatty acid metal salt particles to be embedded in the toner surface as shown in FIG. 3(a).

### (2-6) Second External Addition Step S6

In the second external addition step S6, the toner particles obtained in the fixation step S5 and the external additive are mixed using a mixer, and the external additive is adhered to the surfaces of the toner base particles to obtain toner particles, which are recovered as a toner (external additive toner).

### (3) Two-Component Developer

The two-component developer of the disclosure is characterized by containing the toner of the disclosure and a carrier.

The two-component developer can be produced by mixing the toner and the carrier using a known mixer. A mass ratio between the toner and the carrier is not particularly limited, and is preferably from 3:97 to 12:88, and more preferably from 5:95 to 10:90.

### (3-1) Carrier

The carrier is stirred and mixed with the toner in a development tank of an image forming device and imparts a desired charge to the toner. The carrier functions as an electrode between a development device and an electrophotographic photoreceptor and carries the charged toner to an electrostatic latent image on the photoreceptor to form a toner image. The carrier is retained on a magnet roller (developing roller) of the development device by magnetic force, used in development, and then returns to the development tank again, where the carrier is stirred and mixed with new toner again. In this manner, the carrier is repeatedly used until the end of its life.

The carrier of the two-component developer of the disclosure is composed of a carrier core material and a resin coating layer coating a surface of the carrier core material, and the resin coating layer may be treated with a coupling agent.

An average particle size of the carrier is not particularly limited, but is preferably from 10 to 100 μm, and more preferably from 20 to 50 μm.

### (3-1) Carrier Core Material

The carrier core material commonly used in the art can be used, and examples thereof include magnetic metals such as iron, copper, nickel, and cobalt, and magnetic metal oxides such as ferrite and magnetite. By using these carrier core materials, it is possible to produce a carrier suitable for a developer used in a magnetic brush developing method. Among these carrier core materials, particles including a ferrite component are preferable.

Ferrite has a high saturation magnetization and can be used to produce a coated carrier having low density. Thus, when ferrite is used in a developer, the coated carrier is less likely to adhere to the electrophotographic photoreceptor and a soft magnetic brush is formed, so that it is possible to obtain an image having high dot reproducibility.

Examples of the ferrite include zinc-based ferrite, nickel-based ferrite, copper-based ferrite, barium ferrite, strontium ferrite, nickel-zinc-based ferrite, manganese-magnesium-based ferrite, copper-magnesium-based ferrite, manganese-zinc-based ferrite, manganese-copper-zinc-based ferrite, and manganese-magnesium-strontium-based ferrite.

Ferrite particles can be produced by a known method, for example, by mixing ferrite raw materials such as Fe₂O₃ and Mg(OH)₂, heating the obtained mixed powder in a heating furnace to calcine the mixed powder, cooling the obtained calcined product, pulverizing the cooled calcined product with a vibration mill to obtain particles of about 1 μm, adding a dispersant and water to the pulverized powder to prepare a slurry, wet-pulverizing the obtained slurry with a wet ball mill, and granulating and drying the obtained suspension with a spray dryer.

An average primary particle size of the carrier core material is not particularly limited, but is preferably from 25 to 50 μm, and more preferably from 30 to 50 μm.

When the average primary particle size of the carrier core material is in the ranges described above, the toner can be stably transported to an electrostatic latent image formed on the electrophotographic photoreceptor, and a high-resolution image can be formed over a long period of time. If the average primary particle size of the carrier core material is less than 25 μm, it may be difficult to control the carrier adhesion. On the other hand, if the average primary particle size of the carrier core material exceeds 50 μm, it may not be possible to form a high-resolution image.

### (3-2) Resin Coating Layer

The resin coating layer can be formed by coating a surface of the carrier core material with a resin for a carrier. The resin coating layer can be produced by mixing a resin for a carrier and, if necessary, appropriate amounts of one or more additives selected from conductive particles, an amino group-containing silane coupling agent, a bifunctional silicone oil, and the like.

### (3-2-1) Resin for Carrier

The resin used to form the resin coating layer is not particularly limited, and resins commonly used in the art can be used.

The resin forming the resin coating layer is preferably a silicone resin, particularly a crosslinking silicone resin, and may include other resins, as long as preferable characteristics of the resin are not impaired. Examples of the other resins include epoxy resins, urethane resins, phenol resins, acrylic resins, styrene resins, polyamides, polyesters, acetal resins, polycarbonates, vinyl chloride resins, vinyl acetate resins, cellulose resins, polyolefins, and fluororesins, as well as copolymer resins and blended resins thereof. Among these resins, acrylic resins are preferable to achieve high chargeability. For example, to further improve moisture resistance, releasability, and the like of the resin coating layer formed of a silicone resin (particularly, a crosslinking silicone resin), a bifunctional silicone oil may be included.

Examples of commercially available crosslinking silicone resins include products available from Dow Corning Toray Co., Ltd., under trade names: SR2400, SR2410, SR2411, SR2510, SR2405, 840RESIN, and 804RESIN, and products available from Shin-Etsu Chemical Co., Ltd., under trade names: KR350, KR271, KR272, KR274, KR216, KR280, KR282, KR261, KR260, KR255, KR266, KR251, KR155, KR152, KR214, KR220, X-4040-171, KR201, KR5202, and KR3093.

Examples of the acrylic resin include polyacrylate, polymethyl methacrylate, polyethyl methacrylate, poly-n-butyl methacrylate, polyglycidyl methacrylate, fluorine-containing polyacrylate, a styrene-methacrylate copolymer, a styrene-butyl methacrylate copolymer, and a styrene-ethyl acrylate copolymer.

Examples of the commercially available acrylic resin include resins under the trade name of Dianal SE-5437 available from Mitsubishi Rayon Co., Ltd., under the product name of S-LEC PSE-0020 available from Sekisui Chemical Co., Ltd., under the trade name of Himer ST95 available from Sanyo Chemical Industries, Co., Ltd., and under the trade name of FM601 available from Mitsui Chemicals, Inc. The silicone resin can suppress toner spent and improve adhesiveness between the carrier core material and the resin coating layer. Among the silicone resins, a crosslinking silicone resin is preferable.

### (3-3-2) Conductive Fine Particle

The resin coating layer preferably contains conductive fine particles. This makes it possible to stably enhance the ability of the carrier to charge the toner. That is, charge-up of the carrier can be suppressed.

The conductive fine particles are not particularly limited, conductive fine particles commonly used in the art can be used, and examples thereof include conductive carbon black and oxides such as conductive titanium oxide and conductive tin oxide. Addition of carbon black even in a small amount can contribute to electrical conductivity, and is suitable for a black toner.

On the other hand, in a color toner, conductive titanium oxide doped with antimony is suitably used to eliminate concerns about detachment of carbon black from the resin coating layer.

A blending amount of the conductive fine particles is not particularly limited, but is preferably from 1 to 25 parts by mass and more preferably from 1 to 20 parts by mass per 100 parts by mass of the resin used to form the resin coating layer.

When the blending amount of the conductive fine particles is less than 1 part by mass, an effect obtained by blending the conductive fine particles may not be achieved. On the other hand, when the blending amount of the conductive fine particles exceeds 25 parts by mass, the resin coating layer may not be able to be uniformly formed.

### (3-2-3) Coupling Agent

Further, the resin coating layer of the carrier may contain a silane coupling agent for the purpose of adjusting a charge amount. Specifically, a silane coupling agent having an electron-donating functional group is preferable, and specific examples thereof include an amino group-containing silane coupling agent.

As the amino group-containing silane coupling agent, a known one can be used, and examples thereof include those represented by the following general formula (II).

(Y)ₙSi(R)ₘ (II)

(where m R's are the same or different alkyl groups, alkoxy groups or chlorine atoms, n Y's are the same or different hydrocarbon groups containing amino groups, and m and n are each an integer of from 1 to 3, provided that m+n=4.)

In the general formula (II), examples of the alkyl group represented by R include linear or branched alkyl groups having from 1 to 4 carbon atoms such as a methyl group, an ethyl group, a propyl group, an isopropyl group, a butyl group, an isobutyl group, and a tert-butyl group. Among these, a methyl group, an ethyl group, and the like are preferable.

In the general formula (II), examples of the alkoxy group represented by R include linear or branched alkoxy groups having from 1 to 4 carbon atoms such as a methoxy group, an ethoxy group, a propoxy group, an isopropoxy group, a butoxy group, an isobutoxy group, and a tert-butoxy group.

Among these, a methoxy group, an ethoxy group, and the like are preferable.

In the general formula (II), examples of the hydrocarbon group containing an amino group and represented by Y include-(CH₂)a-X (where X represents an amino group, an aminocarbonylamino group, an aminoalkylamino group, a phenylamino group, or a dialkylamino group, and a is an integer of from 1 to 4), and -Ph-X (where X is as defined above, and -Ph- is a phenylene group).

Specific examples of the amino group-containing silane coupling agent include the following compounds.
H₂N(H₂C)₃Si(OCH₃)₃
H₂N(H₂C)₃Si(OC₂H₅)₃
H₂N(H₂C)₃Si(CH₃)(OCH₃)₂
H₂N(H₂C)₂HN(H₂C)₃Si(CH₃)(OCH₃)₂
H₂NOCHN(H₂C)₃Si(OC₂H₅)₃
H₂N(H₂C)₂HN(H₂C)₃Si(OCH₃)₃
H₂N-Ph-Si(OCH₃)₃ (where-Ph-represents a p-phenylene group)
Ph-HN(H₂C)₃Si(OCH₃)₃ (where Ph-represents a phenyl group)
(H₉C₄)₂N(H₂C)₃Si(OCH₃)₃

One of the amino group-containing silane coupling agents can be used alone, or two or more thereof can be used in combination.

An amount of the amino group-containing silane coupling agent used can be appropriately set within a range where a sufficient charge is imparted to the toner and, for example, mechanical strength of the coating layer is not significantly reduced, and is preferably 15 parts by weight or less, and more preferably from 5 to 15 parts by weight, per 100 parts by weight of the resin contained in the coating resin composition.

When the blending amount of the coupling agent is within the above-described range, a sufficient charge can be imparted to the toner without significant reduction of the mechanical strength of the resin coating layer.

### (4) Image Forming Device

The image forming device of the disclosure is an image forming device that forms an image by forming an electrostatic latent image on a surface of an electrophotographic photoreceptor and transferring a toner developed on the electrostatic latent image to a transfer receiving material, characterized in that the toner is the toner of the disclosure.

The image forming device of the disclosure may include a device selected from a fixer that fixes a transferred toner image on a recording medium to form an image, a cleaner that removes and recovers toner remaining on the photoreceptor, and a charge neutralizer that neutralizes surface charge remaining on the photoreceptor.

Hereinafter, the image forming device of the disclosure and operation thereof will be described using the drawings, but the image forming device of the disclosure is not limited thereby.

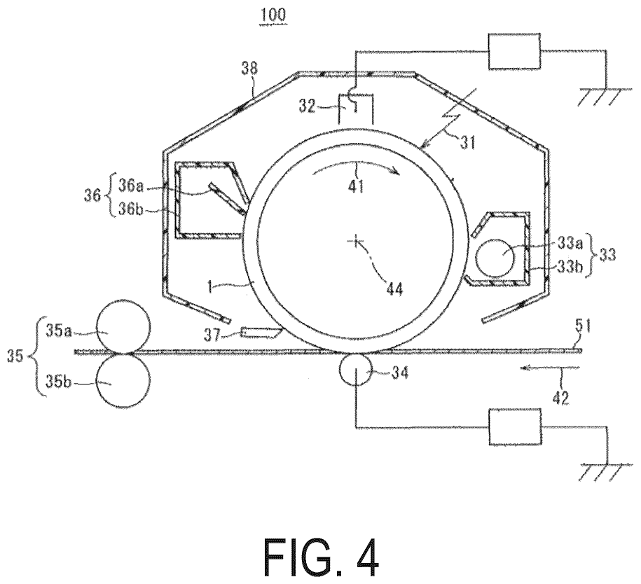

FIG. 4 is a schematic side view showing an example of a configuration of a main portion of an image forming device 100 of the disclosure.

The image forming device (laser printer) 100 of FIG. 4 includes a photoreceptor 1 of the disclosure, an exposurer (semiconductor laser) 31, a charger (charger) 32, a developing device (developing device) 33, a transferer (transfer charger) 34, a conveyor belt (not illustrated), a fixer (fixer) 35, and a cleaner (cleaner) 36. Reference numeral 51 denotes a recording medium (recording paper or transfer paper).

The photoreceptor 1 is rotatably supported on a main body of the image forming device 100 and is driven to rotate around a rotation axis 44 in a direction of an arrow 41 with a driver not illustrated. The driver includes, for example, an electric motor and a reduction gear, and drives the photoreceptor 1 to rotate at a predetermined circumferential velocity by conveying the driving force to a base constituting a core body of the photoreceptor 1. The charger 32, the exposurer 31, the developing device 33, the transferer 34, and the cleaner 36 are provided in this order along an outer circumferential surface of the photoreceptor 1 from upstream to downstream in the direction of rotation of the photoreceptor 1 indicated by the arrow 41.

The photoreceptor 1 is a main component of the image forming device involved in a series of steps of image formation, and has a layer structure in which at least a photosensitive layer is laminated on a conductive support. The photosensitive layer may be either a laminated photosensitive layer in which a charge generating layer containing a charge generating substance and a charge transporting layer containing a charge transporting substance are laminated in this order, or a single-layer photosensitive layer containing both a charge generating substance and a charge transporting substance, but a function-separated laminated photosensitive layer is preferable, and a charge transporting layer thereof may be a two layer type of a first charge transporting layer and a second charge transporting layer also having a function of a surface protective layer, which are laminated in order on the charge generating layer.

The charger 32 is a charger that uniformly charges the outer circumferential surface of the photoreceptor 1 to a predetermined potential.

Examples of the charger include a contactless charging system, such as a corona charging system with an electrification charger, and a contact charging system with a charging roller or a charging brush.

The exposurer 31 includes a semiconductor laser as a light source and exposes the charged outer circumferential surface of the photoreceptor 1 according to image information by irradiating the surface of the photoreceptor 1 between the charger 32 and the developing device 33 with a laser beam emitted from the light source. The light is repeatedly scanned in a main scanning direction, i.e., a direction in which the rotation axis 44 of the photoreceptor 1 extends, and these are imaged to sequentially form electrostatic latent images on the surface of the photoreceptor 1. That is, the irradiation and non-irradiation of the laser beam cause a difference in the charge amount on the photoreceptor 1 uniformly charged by the charger 32, which results in formation of an electrostatic latent image.

The developing device 33 is a developing device that develops an electrostatic latent image with a developer (toner), the electrostatic latent image being formed on the surface of the photoreceptor 1 by exposure, and is provided to face the photoreceptor 1, and includes: a developing roller 33a that supplies a toner to the outer circumferential surface of the photoreceptor 1; and a casing 33b that rotatably supports the developing roller 33a around a rotation axis parallel to the rotation axis 44 of the photoreceptor 1 and that contains a developer containing the toner in an internal space of the casing.

The transfer charger 34 is a transferer that transfers a toner image onto a transfer paper 51, the toner image being a visible image formed on the outer circumferential surface of the photoreceptor 1 by development, and the transfer paper 51 being a recording medium supplied between the photoreceptor 1 and the transfer charger 34 from a direction of an arrow 42 by a conveyor not illustrated. The transfer charger 34 is, for example, a contact type transferer including a charger and transferring the toner image onto the transfer paper 51 by applying, to the transfer paper 51, a charge with a polarity opposite from that of the toner.

The cleaner 36 is a cleaner that removes and recovers the toner remaining on the outer circumferential surface of the photoreceptor 1 after the transfer operation by the transfer charger 34 and includes: a cleaning blade 36a that peels off the toner remaining on the outer circumferential surface of the photoreceptor 1, and a recovery casing 36b that contains the toner peeled off by the cleaning blade 36a. In addition, the cleaner 36 is provided together with a discharging lamp not illustrated.

Furthermore, the image forming device 100 is provided with the fixer 35, which is a fixer that fixes the transferred image, on the downstream side to which the transfer paper 51 that has passed between the photoreceptor 1 and the transfer charger 34 is conveyed. The fixer 35 includes a heating roller 35a including a heater not illustrated and a pressure roller 35b provided to face the heating roller 35a and to be pressed against the heating roller 35a to form a contact portion. Reference numeral 37 denotes a separator that separates the transfer paper and the photoreceptor, and reference numeral 38 denotes a housing (casing) that contains the devices of the image forming device.

The image forming operation with the image forming device 100 is performed as follows.

First, when the photoreceptor 1 is driven to rotate in the direction of the arrow 41 by the driver, the surface of the photoreceptor 1 is uniformly charged to a predetermined positive potential by the charger 32 provided upstream in the direction of rotation of the photoreceptor 1 from the image formation point of light by the exposurer 31.

Then, the surface of the photoreceptor 1 is irradiated with light corresponding to image information from the exposurer 31. This exposure removes the surface charge of the light-irradiated portion in the photoreceptor 1. This causes a difference between the surface potential of the light-irradiated portion and the surface potential of the non-light-irradiated portion and forms an electrostatic latent image.

The toner is supplied from the developing device 33 provided downstream in the direction of rotation of the photoreceptor 1 from the image formation point of light by the exposurer 31 to the surface of the photoreceptor 1, on which the electrostatic latent image has been formed, and this develops an electrostatic latent image and forms a toner image.

The transfer paper 51 is supplied between the photoreceptor 1 and the transfer charger 34 in synchronization with the exposure of the photoreceptor 1. The transfer charger 34 applies a charge with a polarity opposite from that of the toner to the supplied transfer paper 51, and the toner image formed on the surface of the photoreceptor 1 is transferred onto the transfer paper 51.

The transfer paper 51 onto which the toner image has been transferred is conveyed to the fixer 35 by the conveyor and is heated and pressed when passing through the contact portion between the heating roller 35a and the pressure roller 35b of the fixer 35, and the toner image is fixed on the transfer paper 51 to form a robust image. The transfer paper 51 on which the image has been thus formed is ejected to the outside of the image forming device 100 by the conveyor.

On the other hand, the toner remaining on the surface of the photoreceptor 1 even after the transfer of the toner image by the transfer charger 34 is peeled off from the surface of the photoreceptor 1 and recovered by the cleaner 36. The charge on the surface of the photoreceptor 1 from which the toner has been thus removed is removed by light from the discharging lamp, and the electrostatic latent image on the surface of the photoreceptor 1 disappears. Thereafter, the photoreceptor 1 is further driven to rotate, and a series of operations starting from charging is repeated again to continuously form an image.

The image forming device 100 described above is a monochrome image forming device (printer) but may be, for example, a color image forming device with an intermediate transfer system capable of forming a color image. Specifically, the image forming device may be a full-color image forming device with a configuration, which is called a tandem type, in which a plurality of electrophotographic photoreceptors on each of which a toner image is formed are arranged side by side in a predetermined direction (e.g., in a horizontal direction H or in a substantially horizontal direction H). In addition, the image forming device 100 may be another color image forming device, a copier, a multi-function printer, or a facsimile machine.

### EXAMPLES

The disclosure will be specifically described below by Production Examples, Examples, and Comparative Examples, but the disclosure is not limited to the following Examples as long as the gist of the disclosure is not exceeded.

Physical properties of the materials used and the toner base particles obtained in Examples and Comparative Examples, and the two-component developers containing the toner base particles were measured by the following methods.

### Volume Average Particle Size of Toner Particle

To 50 mL of an electrolytic solution (available from Beckman Coulter, K.K., trade name: ISOTON-II), 20 mg of a sample and 1 mL of a sodium alkyl ether sulfate are added. The mixture is subjected to dispersion treatment at a frequency of 20 kHz for 3 minutes using an ultrasonic disperser (available from As One Corporation, Desktop Dual Frequency Ultrasonic Cleaner, model: VS-D100), and a measurement sample is prepared. The obtained measurement sample is measured using a particle size distribution measuring device (available from Beckman Coulter, K.K., model: Multisizer 3) under conditions of an aperture size of 100 μm and the number of measurement particles of 50000 counts, and the volume average particle size (μm) is determined from the volumetric particle size distribution of the sample particles.

### Embedding Rate of Fatty Acid Metal Salt Particle

The surface of the toner particle is observed with a scanning electron microscope SEM (available from Hitachi High-Technologies Corporation, model: S-4800), and the fatty acid metal salt particles adhering to the surface are photographed. From the obtained image, 100 fatty acid metal salt particles are arbitrarily extracted, the number of particles embedded in the toner particle among the extracted 100 particles is set as N, and (N/100)×100 is set as the ratio (%) of the embedded fatty acid metal salt particles.

### Adhesion Strength of External Additive (Metallic Element of Fatty Acid Metal Salt Particle, Si Element)

A toner is subjected to an adhesion strength test of an external additive according to the following procedure, and a toner after the external additive removal treatment is produced.
(1) To 40 mL of a polyethylene glycol octylphenyl ether aqueous solution (available from KISHIDA CHEMICAL CO., LTD., product name: Triton X-100) having a concentration of 0.2 mass %, 2.0 g of a toner is added and stirred for 15 minutes.
(2) The obtained aqueous solution is irradiated with an ultrasonic wave with an output of 40 μA for 4 minutes using an ultrasonic homogenizer (available from NIHONSEIKI KAISHA LTD., model: US-300T).
(3) Thereafter, the aqueous solution is allowed to stand for 3 hours, and the toner and liberated external additives are separated.
(4) After removing the supernatant, about 50 mL of pure water is added to the precipitate, and the mixture is stirred for 5 minutes.
(5) The mixture is suction-filtered using a membrane filter with a pore size of 1 μm (available from Merck, product name: Millipore).
(6) The toner remaining on the membrane filter is vacuum-dried overnight, and a toner after the external additive removal treatment is produced.

Using 1 g of each of the toners before and after the external additive removal treatment as a specimen, an X-ray intensity derived from a specific element (metallic element of the fatty acid metal salt particles, Si element) in the specimen is measured under the condition of an irradiation diameter of 30 mm using a fluorescent X-ray analyzer (available from Rigaku Corporation, model: ZSX Primus 4), and adhesion strengths (SM and SS) of the respective external additives and a ratio (SS/SM) between the adhesion strengths are calculated by the following formulas.

SM(%)=A/B×100
A: X-ray intensity derived from metallic element of fatty acid metal salt particles after external additive removal treatment
B: X-ray intensity derived from metallic element of fatty acid metal salt particles before external additive removal treatment

SS(%)=C/D×100
C: X-ray intensity derived from Si element of silica particles after external additive removal treatment
D: X-ray intensity derived from Si element of silica particles before external additive removal treatment

### Degree of Embedding of Fatty Acid Metal Salt Particle

The prepared toner was embedded in an epoxy resin, and cut with an ultramicrotome (available from Leica Microsystems GmbH, model: EM UC7) to create an ultrathin slice having a thickness of 100 nm or less.

The obtained ultrathin slice is gas-phase stained using a 0.5% aqueous solution of ruthenium tetroxide (VIII), and observed with a scanning electron microscope SEM (available from Hitachi High-Technologies Corporation, model: S-4800), and a cross section of the toner particle containing fatty acid metal salt particles is photographed.

The positions and sizes of the fatty acid metal salt particles in the obtained image are extracted from a mapping image of the metallic element by an energy dispersive X-ray analyzer (available from Horiba, Ltd., model: EX-350).

From 50 to 100 fatty acid metal salt particles embedded in the toner particle are extracted, and image analysis is performed using image analysis software (name: ImageJ), an area ST of the fatty acid metal salt particles and an area SB of portions thereof embedded in the toner particle are calculated, and an average of a ratio (SB/ST) between the areas ST and SB×100(%) is calculated as the degree of embedding.

### Average Primary Particle Size of External Additive

External additives (silica particles and fatty acid metal salt particles) are each observed (photographed) with a scanning electron microscope SEM (available from Hitachi High-Technologies Corporation, model: S-4800), the particle sizes (major axes) of 100 external additive particles are arbitrarily measured from the obtained image, and an average value of the particle sizes is calculated and set as the average primary particle size.

### Coverage of External Additive

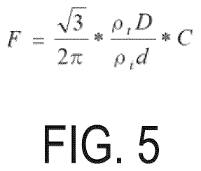

Toner particles are observed (photographed) with a scanning electron microscope SEM (available from Hitachi High-Technologies Corporation, model: S-4800). A model calculation in a projected area is performed using an average particle size D and a specific gravity pt of the toner base particles, and an average particle size d and a specific gravity ρi of each external additive. A coverage by each external additive is calculated using the equation in FIG. 5. C is the number of parts by mass of each external additive added.

### Fluorescent X-Ray Intensity of External Additive on Printed Matter

The prepared developer and toner are filled in a development device and a toner cartridge of a color multi-function printer (available from Sharp Corporation, model: BP-20C25), respectively. Next, a solid image (ID: from 1.6 to 1.8) is output on an A3 sheet. The obtained image is cut into a square of 40 mm×40 mm, and an X-ray intensity P of a specific element in the external additive (metallic element of the fatty acid metal salt particles) is measured under the condition of an irradiation diameter of 30 mm using a fluorescent X-ray analyzer (available from Rigaku Corporation, model: ZSX Primus 4), with the printed surface facing upward.

Further, an X-ray intensity T of the specific element in the external additive (metallic element of the fatty acid metal salt particles) in 1 g of the toner is measured, and a ratio (P/T) between the X-ray intensities P and T×100(%) is calculated.

### Production Example 1: Preparation of Amorphous Polyester-Based Resin

In a reaction vessel with a capacity of 5 L, 440 g (2.7 mol) of terephthalic acid, 235 g (1.4 mol) of isophthalic acid, 7 g (0.05 mol) of adipic acid, 554 g (8.9 mol) of ethylene glycol, and 0.5 g of tetrabutoxytitanate as a polymerization catalyst were placed, and the mixture was reacted at 210° C. under a nitrogen stream for 5 hours while generated water and ethylene glycol were distilled off. Thereafter, the mixture was reacted under a reduced pressure of from 5 to 20 mmHg for 1 hour. Then, 103 g (0.54 mol) of trimellitic anhydride was added, and the mixture was reacted under normal pressure for 1 hour. The mixture was then reacted under a reduced pressure of from 20 to 40 mmHg, and a resin was taken out at a predetermined softening point. The amount of the recovered ethylene glycol was 219 g (3.5 mol). The obtained resin was cooled to room temperature and then pulverized into particles, and an amorphous polyester resin was produced.

The amorphous polyester-based resin had a Tg of 56° C. and a Tm of 135° C.

### Production Example 2: Preparation of Crystalline Polyester-Based Resin

In a reaction vessel with a capacity of 5 L, 132 g (1.12 mol) of 1,6-hexanediol, 230 g (1.0 mol) of 1,10-decanedicarboxylic acid, and 3 g of tetrabutoxytitanate as a polymerization catalyst were placed, and the mixture was reacted at 210° C. under normal pressure for 5 hours while generated water was distilled off. Thereafter, the reaction was continued under a reduced pressure of from 5 to 20 mmHg, and a resin was taken out when the acid value became 2 mg KOH/g or less. The obtained resin was cooled to room temperature and then pulverized into particles, and a crystalline polyester resin was produced.

The crystalline polyester-based resin had a Tm of 77.5° C.

### Production Example 3: Preparation of Toner Base Particle

Toner base particles used in Examples were prepared as follows using the following materials.
Binder resin: amorphous polyester-based resin (Production Example 1) 67 mass %: crystalline polyester-based resin (Production Example 2) 20 mass %
Colorant: C.I. Pigment Blue 15:3 (available from DIC Corporation) 7 mass %
Release agent: monoester-based wax (available from NOF Corporation, product name: WEP-3) 5 mass %
Charge control agent: salicylic acid-based compound (available from Orient Chemical Industries Co., Ltd., product name: Bontron E-84) 1 mass %

The above materials were premixed for 5 minutes using an air flow mixer (Henschel mixer, available from Mitsui Mining Corporation (now NIPPON COKE & ENGINEERING CO., LTD.), model: FM20C), and a mixture was produced [mixing step].

The obtained mixture was melt-kneaded using an open roll type continuous kneading machine (available from Mitsui Mining Corporation (now NIPPON COKE & ENGINEERING CO., LTD.), model: MOS320-1800), and a melt-kneaded product was produced [kneading step].

The setting conditions of the open rolls included a supply side temperature of the heating roll of 130° C., a discharge side temperature of the heating roll of 100° C., a supply side temperature of the cooling roll of 40° C., and a discharge side temperature of the cooling roll of 25° C. Rolls with a diameter of 320 mm and an effective length of 1550 mm were used as the heating roll and the cooling roll, and the gaps between the rolls on the supply side and the discharge side were both set at 0.3 mm. In addition, the rotation speed of the heating roll was set at 75 rpm, that of the cooling roll at 65 rpm, and the supply amount of the toner raw material was set at 5.0 kg/h.

The obtained melt-kneaded product was cooled with a cooling belt and then coarsely pulverized using a speed mill with a q 2 mm screen, to obtain a coarsely pulverized product [coarse pulverization step].

The obtained coarsely pulverized product was finely pulverized using a jet type pulverizer (available from Nippon Pneumatic Mfg. Co., Ltd., model: IDS-2), to obtain a finely pulverized product [fine pulverization step].

The obtained finely pulverized product was classified using an elbow jet classifier (available from Nittetsu Mining Co., Ltd., model: EJ-LABO), and 3900 g of toner base particles having an average primary particle size of 6.60 μm were obtained [classification step].

### Production Example 4: Preparation of Carrier

A coating resin liquid was obtained by dissolving, in 12 parts by mass of toluene, 0.375 parts by mass of a coating resin 1 (silicone-based, available from Shin-Etsu Chemical Co., Ltd., trade name: KR240) and 0.375 parts by mass of a coating resin 2 (available from Shin-Etsu Chemical Co., Ltd., trade name: KR251), and then adding and dispersing, in the solution, 0.0375 parts by mass of conductive particles (available from Cabot Corporation, trade name: VULCAN XC-72) and 0.0225 parts by mass of a coupling agent (available from Dow Corning Toray Co., Ltd., trade name: AY43-059).

By an immersion method, 12.8 parts by mass of the obtained coating resin liquid was coated on the surface of 100 parts by mass of a ferrite carrier core material (volume average particle size: 35 μm, available from Powdertech Co., Ltd., product name: EF-35). Thereafter, the resin was cured at a curing temperature of 200° C. for a curing time of 1 hour, and sieved with a sieve with an opening of 150 μm to obtain 5000 g of a carrier.

### Production Example 5: Preparation of Zinc Stearate

In Example 1 which will be described later, zinc stearate (average primary particle size: 0.5 μm, available from NOF Corporation, product name: MZ-2) was used as the fatty acid metal salt particles.

Zinc stearate having different average primary particle sizes and used in other Examples was prepared by the following method.

In a container of a bead mill (volume: 0.2 L, available from Ashizawa Finetech Ltd., product name: Labstar (registered trademark) Mini, model: HFM02), 50 g of a zinc stearate powder (particles) and 250 g of isopropyl alcohol were stirred and mixed to disperse the zinc stearate powder in the isopropyl alcohol, to obtain a slurry. To the obtained slurry, 540 g of zirconia beads with a diameter of 0.3 mm were added and mixed by stirring, and pulverized with the bead mill for 1 hour.

The zirconia beads were separated from the obtained pulverized product, and the separated slurry was dried at 150° C. for 4 hours. The obtained dried product was passed through a collision pulverizer to loosen the aggregation, and a zinc stearate powder with an average primary particle size smaller than that before the pulverization was obtained. This process was repeated three times to obtain three types of zinc stearate powders having different average primary particle sizes.

The three types of zinc stearate powders thus obtained were uniformly mixed in an arbitrary combination and at a mixing ratio, thereby obtaining zinc stearate powders (particles) having average primary particle sizes of 0.05 μm, 0.1 μm, 1.0 μm, and 1.5 μm.

Zinc stearate (average primary particle size: 0.5 μm, available from NOF Corporation, product name: MZ-2) was used as a starting material for the zinc stearate powders having average primary particle sizes of 0.05 μm and 0.1 μm.

Zinc stearate (average primary particle size: 7 μm, available from Sakai Chemical Industry Co., Ltd., product name: SZ-2000) was used as a starting material for the zinc stearate powders having average primary particle sizes of 1.0 μm and 1.5 μm.

### Example 1

### Preparation of Toner

A toner of Example 1 was prepared as follows using the following materials.
Toner base particles (Production Example 3) 100 parts by mass
Silica particles (average primary particle size: 12 nm, surface treated with hexamethyldisilazane, available from Nippon Aerosil Co., Ltd., product name: AEROSIL (registered trademark) RX200) 1.25 parts by mass
Silica particles (average primary particle size: 115 nm, available from Cabot Corporation, product name: TG-C191) 1.25 parts by mass
Zinc stearate (average primary particle size: 0.5 μm, available from NOF Corporation, product name: MZ-2) 2 parts by mass

The above materials were mixed for 3 minutes using an air flow mixer (Henschel mixer, available from Mitsui Mining Corporation (now NIPPON COKE & ENGINEERING CO., LTD.), model: FM20C) to obtain 3000 g of a first external additive toner before fixation [first external addition step].

The obtained external additive toner base particles were heat-treated using a hot air type spheroidizing device (available from Nippon Pneumatic Mfg. Co., Ltd., model: Meteorainbow MR-10) under the conditions of an input amount (supply amount) of the external additive toner base particles of 3.0 kg/h, a supply amount of hot air (hot air flow rate) of 1180 L/min, a hot air temperature of 200° C., a supply pressure of cooling air of 0.15 Mpa, a supply amount of air from the secondary air injection nozzle of 230 L/min, and a distance of 20 mm between the cooling air intake port and the collision member, thereby obtaining 2220 g of a first external additive toner [fixation step].

First external additive toner obtained in fixation step (heat treatment) 100 parts by mass Silica particles (average primary particle size: 12 nm, surface treated with dimethylpolysiloxane, available from Nippon Aerosil Co., Ltd., product name: AEROSIL (registered trademark) RY200) 1.25 parts by mass

Silica particles (average primary particle size: 115 nm, available from Cabot Corporation, product name: TG-C191) 1.25 parts by mass

The above materials were mixed at a rotation speed of 2500 rpm for 3 minutes using an air flow mixer (Henschel mixer, available from Mitsui Mining Corporation (now NIPPON COKE & ENGINEERING CO., LTD.), model: FM20C) to obtain 2000 g of a second external additive toner (toner) [second external addition step].

### Preparation of Two-Component Developer

The obtained external additive toner and carrier (Production Example 4) were mixed with a V-shaped mixer (available from Tokuju Corporation, trade name: V-5) for 20 minutes to give a toner concentration of 7 mass %, and 4000 g of a two-component developer of Example 1 was produced.

### Examples 2 to 23 and Comparative Examples 1 to 8

Toners and two-component developers containing the toners of Examples 2 to 23 and Comparative Examples 1 to 8 were obtained in the same manner as in Example 1, except that the material of the fatty acid metal salt particles, the average primary particle size and the external addition amount thereof, the average primary particle size and the external addition time of the large silica particles in the external addition step (first external addition step), the heat treatment temperature, the supply amount, and the hot air flow rate in the fixation step, and the average primary particle size of the small silica particles in the second external addition step were changed as shown in Tables 1 and 2, respectively.

The materials different from those used in Example 1 were as follows.
Calcium stearate (average primary particle size: 0.7 μm, available from NOF Corporation, product name: MC-2)
Large silica particles (average primary particle size: 65 μm, surface treated with octylsilane, available from Cabot Corporation, product name: TG-C390)
Large silica particles (average primary particle size: 180 μm, surface treated with hexamethyldisilazane, available from Shin-Etsu Chemical Co., Ltd., product name: QSG-170)
Large silica particles (average primary particle size: 50 μm, surface treated with hexamethyldisilazane, available from Cabot Corporation, product name: TG-C413)
Large silica particles (average primary particle size: 200 μm, surface treated with hexamethyldisilazane, available from Cabot Corporation, product name: TG-C602)

Small silica particles (average primary particle size: 5 μm, surface treated with hexamethyldisilazane, available from Nippon Aerosil Co., Ltd., product name: AEROSIL (registered trademark) RX300)

Small silica particles (average primary particle size: 7 μm, surface treated with dodecylsilane, available from Nippon Aerosil Co., Ltd., product name: AEROSIL (registered trademark) R976S) Small silica particles (average primary particle size: 20 μm, surface treated with hexamethyldisilazane, available from Nippon Aerosil Co., Ltd., product name: AEROSIL (registered trademark) NX130)

Small silica particles (average primary particle size: 30 μm, surface treated with hexamethyldisilazane, available from Nippon Aerosil Co., Ltd., product name: AEROSIL (registered trademark) NAX50)

### Evaluations

### Filming in High-Temperature and High-Humidity Environment

The prepared developer and toner were filled in a development device and a toner cartridge of a color multi-function printer (available from Sharp Corporation, model: BP-20C25), respectively. Next, a continuous print test was performed on 50000 A4 sheets in an environment at a temperature of 35° C. and a relative humidity of 85% in such a manner that square solid images (ID=from 1.45 to 1.50) each having one side of 10 mm were formed at three positions, i.e., the central portion and both end portions in the axial direction of the developing roller.

Thereafter, a solid image (ID: from 1.6 to 1.8) and a halftone (HT) image (ID: from 0.5 to 0.7) were output on an A3 sheet, and the obtained images were visually observed to evaluate the filming resistance according to the following criteria.
⊚ (Excellent): No image defect (white streak or the like) is observed in either the solid image or the HT image, and no streak is observed on the surface of the photoreceptor
∘ (Good): No image defect (white streak or the like) is observed in either the solid image or the HT image, but streaks are slightly observed on the surface of the photoreceptor
Δ (Acceptable): No image defect (white streak or the like) is observed in the solid image, but a slight image defect (white streak or the like) can be confirmed in the HT image, and streaks are partially observed on the surface of the photoreceptor
× (Unacceptable): A defect (white streak or the like) can be confirmed in both the solid image and the HT image, and streaks are observed on the entire surface of the photoreceptor

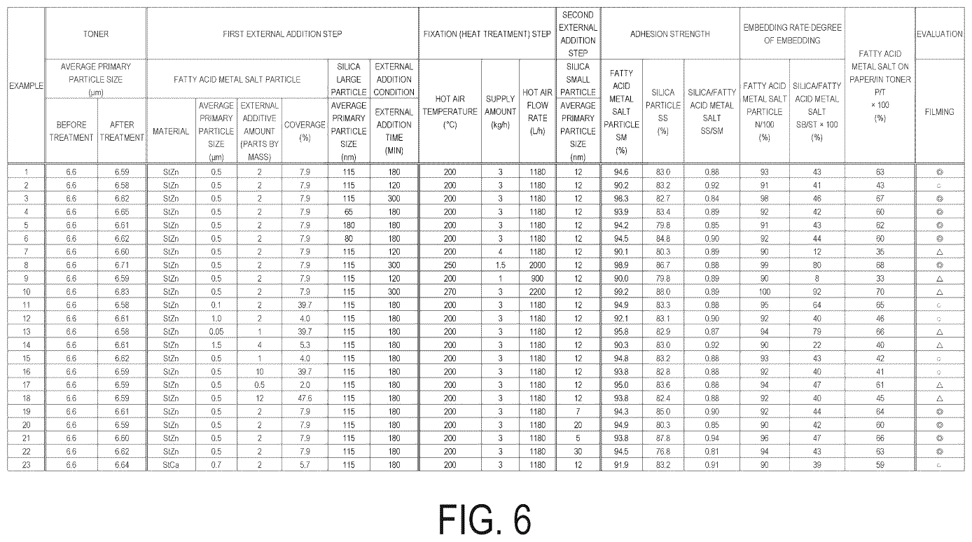

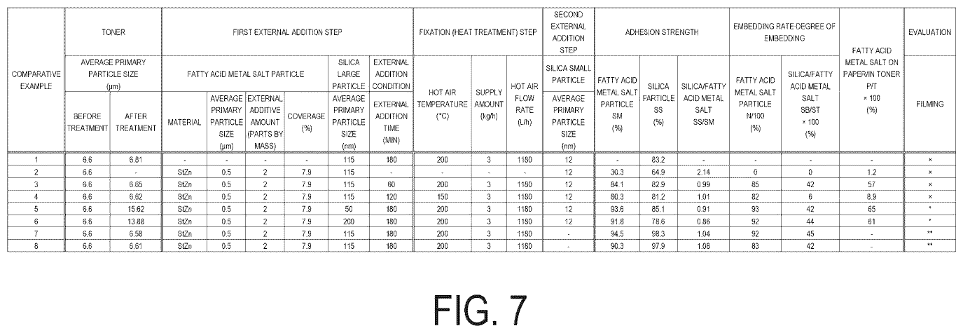

The obtained evaluation results are shown in FIG. 6 (Examples) and FIG. 7 (Comparative Examples) together with the constitutions of the toners and the two-component developers, the preparation conditions and physical properties thereof.

In the tables, StZ and StC are abbreviations for zinc stearate and calcium stearate, respectively, and “−” means that the corresponding component was not used or the corresponding treatment was not performed.

In the evaluation/filming in FIG. 7, “*” means that the evaluation was impossible due to coalescence, and “**” means that the evaluation was impossible due to low fluidity.

FIG. 6 and FIG. 7 reveal the following.
(1) The toners and two-component developers having the constituent features of the disclosure can exhibit suppression of filming in a high-temperature and high-humidity environment (Examples 1 to 23)
(2) The toners and two-component developers not having the constituent features of the disclosure cannot exhibit suppression of filming in a high-temperature and high-humidity environment

### Comparative Examples 1 to 6

(3) The toners of the disclosure require an embedding ratio of the fatty acid metal salt particles of 90% or more (Comparative Examples 2 to 4)
(4) The toners of the disclosure require an adhesion strength of the fatty acid metal salt particles of 90% or more (Comparative Examples 2 to 4)
(5) The toners of the disclosure need to include at least large silica particles having an average primary particle size of from 60 to 180 nm (Examples 4 to 6 and Comparative Example 5)
(6) In the toners of the disclosure, the ratio of the adhesion strength of the silica particles to the adhesion strength of the fatty acid metal salt particles needs to be less than 1 (Comparative Examples 2 and 4)
(7) The degree of embedding of the fatty acid metal salt particles is preferably from 10 to 80%

### Examples 7 to 10

(8) The average primary particle size of the fatty acid metal salt particles is preferably from 0.1 to 1.0 μm (Examples 11 to 14)
(9) The coverage of the fatty acid metal salt particles on the surface of the toner base particle is preferably from 4 to 40% (Examples 15 to 18)
(11) The ratio (P/T)×100 is preferably from 50 to 70%, the ratio (P/T) being a ratio of the X-ray intensity P derived from the metallic element of the fatty acid metal salt particles when a solid image is printed using the toner to the X-ray intensity T derived from the metallic element of the fatty acid metal salt particles in the toner (Examples 11 and 18)
(12) When the toner further includes small silica particles surface-treated with a silicone oil as the external additive, the average primary particle size of the small silica particles is preferably from 7 to 20 nm (Examples 19 and 20)
(13) As the fatty acid metal salt particles, particles of zinc stearate and calcium stearate are preferable, and zinc stearate is more preferable from the viewpoint of a high effect of suppressing the adhesion of the toner (Examples 1 and 23)
(14) The toners in which the ratio SS/SM of the adhesion strength SS of the silica particles to the adhesion strength SM of the fatty acid metal salt particles is more than 1 have low fluidity, and cannot achieve fluidity as a toner and also cannot achieve the excellent effects obtained by the toner of the disclosure (Comparative Examples 7 and 8)

### REFERENCE SIGNS LIST

1 Electrophotographic photoreceptor
11 Drum (electrophotographic photoreceptor)
12 Drum surface
13 Blade scratch
14 Pass-through scratch
15 Large silica particle
16 Toner
17 Fatty acid metal salt particle
18 Toner from which fatty acid metal salt particles are detached
19 Toner filming (Filming)
31 Exposurer (semiconductor laser)
32 Charger (charger)
33 Developing device (developing device)
33a Developing roller
33b Casing
34 Transferer (transfer charger)
35 Fixer (fixer)
35a Heating roller
35b Pressure roller
36 Cleaner (cleaner)
36a Cleaning blade
36b Recovery casing
37 Separator
38 Housing
41, 42 Arrow
44 Rotation axis
51 Recording medium (recording paper or transfer paper)
100 Image forming device (laser printer)

1. A toner comprising at least a toner base particle and an external additive externally added to a surface of the toner base particle, wherein
the external additive comprises fatty acid metal salt particles and silica particles,
at least some of the fatty acid metal salt particles are embedded in the toner base particle,
a ratio (N/100)×100 (embedding rate) % is 90% or more, the ratio (N/100) being a ratio of a number N of the fatty acid metal salt particles embedded in the toner base particle to 100 arbitrarily extracted fatty acid metal salt particles, in the surface of the toner base particle comprising the fatty acid metal salt particles embedded in the toner base particle,
a ratio SM, which is A/B×100 (adhesion strength) %, is 90% or more, the A/B being a ratio of an X-ray intensity A derived from a metallic element of the fatty acid metal salt particles using 1 g of the toner after external additive removal treatment as a specimen to an X-ray intensity B derived from the metallic element of the fatty acid metal salt particles using 1 g of the toner before the external additive removal treatment as a specimen, in fluorescent X-ray analysis with an irradiation diameter of 30 mm,
the silica particles comprise at least large silica particles having an average primary particle size of from 60 to 180 nm, and
a ratio SS/SM of a ratio SS to the ratio SM is less than 1, the ratio SS being C/D×100 (adhesion strength) %, the C/D being a ratio of an X-ray intensity C derived from an Si element of the silica particles using 1 g of the toner after the external additive removal treatment as a specimen to an X-ray intensity D derived from the Si element of the silica particles using 1 g of the toner before the external additive removal treatment as a specimen, in the fluorescent X-ray analysis with the irradiation diameter of 30 mm.

2. The toner according to claim 1, wherein an average value of a ratio (SB/ST)×100 (degree of embedding) % is from 10 to 80%, the ratio (SB/ST) being a ratio of an area SB of portions of the fatty acid metal salt particles embedded in the toner base particle to an area ST of the 100 arbitrarily extracted fatty acid metal salt particles embedded in the toner base particle, in a cross section of the toner base particle comprising the fatty acid metal salt particles embedded in the toner base particle.

3. The toner according to claim 1, wherein the fatty acid metal salt particles have an average primary particle size of from 0.1 to 1.0 μm.

4. The toner according to claim 1, wherein the fatty acid metal salt particles have a coverage of from 4 to 40% with respect to the surface of the toner base particle.

5. The toner according to claim 1, wherein a ratio (P/T)×100 is from 50 to 70%, the ratio (P/T) being a ratio of an X-ray intensity P derived from the metallic element of the fatty acid metal salt particles using, as a specimen, an image of 40×40 mm when a solid image is printed using the toner to an X-ray intensity T derived from the metallic element of the fatty acid metal salt particles using 1 g of the toner as a specimen, in the fluorescent X-ray analysis with the irradiation diameter of 30 mm.

6. The toner according to claim 1, further comprising, as an external additive, small silica particles having an average primary particle size of from 7 to 20 nm and surface-treated with a silicone oil.

7. The toner according to claim 1, wherein the fatty acid metal salt particles are particles of zinc stearate.

8. A method for producing the toner according to claim 1, comprising:
a kneading step S1 of mixing and melt-kneading toner raw materials to obtain a kneaded product;
a pulverization step S2 of pulverizing the obtained kneaded product to obtain pulverized toner particles;
a classification step S3 of classifying the obtained pulverized toner particles to obtain toner base particles;
an external addition step S4 of adding large silica particles and fatty acid metal salt particles as external additives to the obtained toner base particles to obtain external additive toner particles; and
a fixation step S5 of heat-treating the obtained external additive toner particles to fix or embed the particles of the external additives to/in a toner surface to obtain a toner; and
optionally, a second external addition step S6 of further adding small silica particles as an external additive to the obtained toner.

9. A two-component developer comprising the toner according to claim 1 and a carrier.

10. An image forming device that forms an image by forming an electrostatic latent image on a surface of an electrophotographic photoreceptor and transferring a toner developed on the electrostatic latent image to a transfer receiving material, wherein the toner is the toner according to claim 1.
